(19) United States
(12) Patent Application Publication
(10) Pub. No.: US 2004/0246962 A1
(43) Pub. Date: Dec. 9, 2004

(54) Dynamically assignable resource class system to directly map 3GPP subscriber communications to a MPLS-based protocol

(76) Inventors: Roy A. Kopeikin, Naperville, IL (US); Suresh Kumar, Naperville, IL (US); Georgios Sfikas, Glyfada (GR); Dimitrios Vasilaras, Swindon (GB)

Correspondence Address: PATTON BOGGS, 1660 LINCOLN ST, SUITE 2050, DENVER, CO, 80264, US

(21) Appl. No.: 10/456,006

(22) Filed: Jun. 6, 2003

(51) Int. Cl. H04L 12/28

(52) U.S. Cl. 370/392; 370/230

(57) ABSTRACT

It is desirable to enhance the current General Packet Radio Service to be able to support the additional stringent delay requirements of the additional service classes defined in the ETSI Universal Mobile Telecommunication Service Phase 2+ General Packet Radio Service recommendations to thereby arrive at a single IP-based integrated network capable of providing all classes of service from conversational to best effort data. To be spectrally efficient for all of these service classes, it is necessary to be able to efficiently multiplex several data sessions with different QoS delay requirements on the same set of channels. The Dynamically Assignable Resource Class System accomplishes this by enhancing the existing slow access procedure implemented in the General Packet Radio Service medium to include fast in-session access capability.

### FIELD OF THE INVENTION

This invention relates to advanced cellular communication networks and, in particular, to a system that enables 3GPP-based systems to allocate “Resource Classes” to a 3G-based Universal Mobile Telecommunication Service (UMTS) subscriber on a per session basis to enable Traffic Engineering, Virtual Private Networks to be implemented, and to directly transition to an all-IP UMTS backbone.

### Problem

It is a problem in legacy cellular communication networks to provide subscribers with data services, such as the Internet, and access to packet-switched data communications. This is due to the fact that legacy cellular communication networks have a circuit-switched architecture designed primarily for voice services, where the network topology is point-to-point in nature. This paradigm represents the historical view of cellular communications as a wireless equivalent of traditional wire-line telephone communication networks, which serve to interconnect a calling party with a called party.

The Internet has emerged as the major driving force behind the development of new communication network technology. There has also been a worldwide explosion in the number of wireless cellular subscribers that generates an ever-increasing demand for both ubiquitous untethered communications and constant service availability. The convergence of these two powerful trends has fostered an exponential growth in the demand for mobile access to Internet applications. However, Internet and other data services require the use of packet-switched data networks to obtain the required performance. The legacy first generation (1G) and second generation (2G) cellular communication networks have a circuit-switched architecture designed primarily for voice services. This has fostered the development of packet-switched network overlays, termed 2.5G networks, which are implemented over existing second generation (2G) cellular communication networks. The 2.5G networks form an interim solution for providing packet-switched data services to existing second generation (2G) cellular communication networks until the full scale development and deployment of third generation (3G) cellular communication networks that provide both circuit-switched voice as well as packet-switched data services. Moreover, the 2.5G networks will thereby provide a legacy platform upon which cost-effective third generation (3G) cellular communication network upgrades can be implemented and deployed.

However, a problem with the General Packet Radio Service packet-switched network overlay is that it is designed primarily for providing only best effort service to bursty data traffic in a spectrally efficient manner. It is extremely well designed for providing this type of service and keeping the necessary level of compatibility and interoperability with GSM. However, 2.5G systems such as General Packet Radio Service are expected to eventually migrate in a graceful and cost-effective manner to full 3G network deployment. Therefore, it is extremely desirable for enhancements of these systems to incorporate higher levels of 3G functionality. One of the main attributes of 3G is to enable new service applications. These new service applications are supported through the definition of supported 3G service classes with varying degrees of quality of service (QoS) requirements, including some with much more stringent delay requirements than the best effort service class. The ETSI Universal Mobile Telecommunication Service Phase 2+ General Packet Radio Service recommendations include the following service classes:

Conversation Class—Preserves conversation pattern with stringent low delay and low error rate requirements. Example: voice service

Streaming Class—Preserves time relation between information elements of the stream. Example: streaming audio, video

Interactive Class—Preserves request response data transfer pattern and data payload content. Example: web browsing

Background Class—Preserves data payload content and best effort service requirement. Example: Background download of email messages

The conversational class has the most stringent low delay requirements followed by the streaming class and the interactive class. The background class is essentially delay-insensitive. Presently, the General Packet Radio Service system only supports the Background Class and does not have the functionality to migrate to serve the additional classes of service.

### Solution

The above-described problems are solved and a technical advance achieved by the present Dynamically Assignable Resource Class System which provides enhancements to the General Packet Radio Service packet-switched network overlay, implemented over existing second generation (2G) cellular communication networks, to support additional classes of service.

It is desirable to enhance the current General Packet Radio Service to be able to support the additional stringent delay requirements of the additional service classes defined in the ETSI Universal Mobile Telecommunication Service Phase 2+ General Packet Radio Service recommendations to thereby arrive at a single IP-based integrated network capable of providing all classes of service from conversational to best effort data. To be spectrally efficient for all of these service classes, it is necessary to be able to efficiently multiplex several data sessions with different QoS delay requirements on the same set of channels. The Dynamically Assignable Resource Class System accomplishes this by enhancing the existing slow access procedure implemented in the General Packet Radio Service medium to include fast in-session access capability. The Radio Access Bearer (RAB) message that provides Traffic Class/Maximum Bit Rate/Guaranteed Bit Rate QoS data is used to accomplish this. The resource class defined by this process is used to enable Traffic Engineering, Virtual Private Networks, and a transition to an all-IP UMTS backbone.

Thus, the Dynamically Assignable Resource Class System only requires software modifications to existing second generation (2G) cellular communication networks and therefore preserves completely the existing network infrastructure and appliance hardware, since it is implemented in the radio access control layer of the General Packet Radio Service protocol.

### BRIEF DESCRIPTION OF THE DRAWINGS

FIGS. 1A & 1B illustrate in block diagram form the overall architecture of a third generation (3G) cellular communication network;

FIG. 2 illustrates the typical translation of a 3G-based Universal Mobile Telecommunication Service (UMTS) subscriber communications to a MPLS-based protocol; and

FIG. 3 illustrates the User Plane—GTP-U/UDP/IP encapsulated in MPLS across lu-ps and Gn interfaces protocol stack for the present Dynamically Assignable Resource Class System.

### DETAILED DESCRIPTION OF THE DRAWINGS

In this description, the phrase “third generation cellular communication network” is used to characterize a network that provides a full complement of packet-based services to mobile subscriber stations. The technical description of the invention is based on the existing General Packet Radio Service packet network overlay on second generation circuit switched cellular communication networks but it is not intended to limit the application of the Quality Packet Radio Service to this environment, this architecture is simply used to illustrate the concepts of the Quality Packet Radio Service.

Cellular Communication Network Philosophy

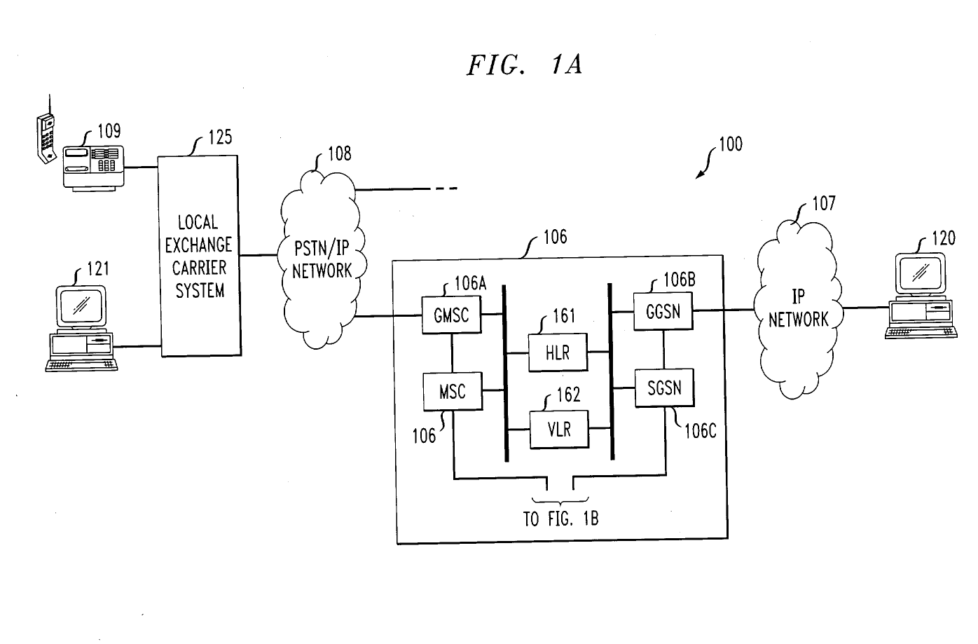

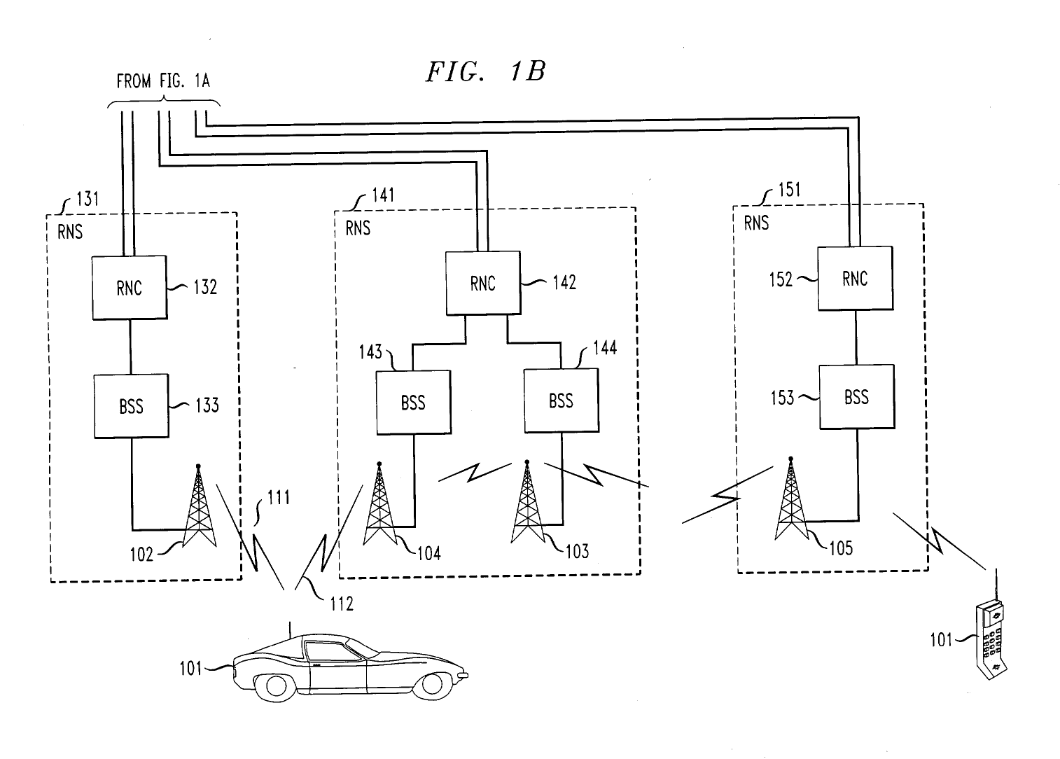

Cellular communication networks 100, as shown in block diagram form in FIGS. 1A & 1B, provide the service of connecting wireless telecommunication customers, each having a mobile subscriber station, to both land-based customers who are served by the common carrier Public Switched Telephone Network (PSTN) 108 as well as other wireless telecommunication customers. In such a network, all incoming and outgoing calls are routed through Mobile Switching Centers (MSC) 106, each of which is connected to a plurality of Radio Network Subsystems (RNS) 131-151 which communicate with mobile subscriber stations 101, 101′ located in the area covered by the cell sites. The mobile subscriber stations 101, 101′ are served by the Radio Network Subsystems (RNS) 131-151, each of which is located in one cell area of a larger service region. Each cell site in the service region is connected by a group of communication links to the Mobile Switching Center 106. Each cell site contains a group of radio transmitters and receivers, termed a “Base Station” herein, with each transmitter-receiver pair being connected to one communication link. Each transmitter-receiver pair operates on a pair of radio frequencies to create a communication channel: one frequency to transmit radio signals to the mobile subscriber station and the other frequency to receive radio signals from the mobile subscriber station. The Mobile Switching Center 106, in conjunction with the Home Location Register (HLR) 161 and the Visitor Location Register (VLR) 162, manages subscriber registration, subscriber authentication, and the provision of wireless services such as voice mail, call forwarding, roaming validation and so on. The Mobile Switching Center 106 is connected to a Gateway Mobile Services Switching Center (GMSC) 106A as well as to the Radio Network Controllers, with the GMSC 106A serving to interconnect the MSC 106 with the PSTN/IP Network 108. In addition, the Radio Network Controllers are connected via Serving GPRS Support Node 106C and thence the Gateway GPRS Support Node GGSN 106B to the Internet. The Radio Network Controllers 132, 142, 152 at each cell site Radio Network Subsystem 131-151 control the transmitter-receiver pairs at the Radio Network Subsystem 131. The control processes at each Radio Network Subsystem also control the tuning of the mobile subscriber stations to the selected radio frequencies. In the case of WCDMA, the system also selects the PN code word to enhance isolation of the communications with the mobile subscriber stations.

In FIG. 1B, the mobile subscriber station 101 is simultaneously communicating with two Base Stations 133 & 143, thus constituting a soft handoff. However, a soft handoff is not limited to a maximum of two Base Stations. When in a soft handoff, the Base Stations serving a given call must act in concert so that commands issued over RF channels 111 and 112 are consistent with each other. In order to accomplish this consistency, one of the serving Base Stations may operate as the primary Base Station with respect to the other serving Base Stations. Of course, a mobile subscriber station 101 may communicate with only a single Base Station if this is determined to be sufficient by the cellular communication network.

The control channels that are available in this system are used to setup the communication connections between the subscriber stations 101 and the Base Station 133. When a call is initiated, the control channel is used to communicate between the mobile subscriber station 101 involved in the call and the local serving Base Station 133. The control messages locate and identify the mobile subscriber station 101, determine the dialed number, and identify an available voice/data communication channel consisting of a pair of radio frequencies and orthogonal coding which is selected by the Base Station 133 for the communication connection. The radio unit in the mobile subscriber station 101 re-tunes the transmitter-receiver equipment contained therein to use these designated radio frequencies and orthogonal coding. Once the communication connection is established, the control messages are typically transmitted to adjust transmitter power and/or to change the transmission channel when required to handoff this mobile subscriber station 101 to an adjacent cell, when the subscriber moves from the present cell to one of the adjoining cells. The transmitter power of the mobile subscriber station 101 is regulated since the magnitude of the signal received at the Base Station 133 is a function of the subscriber station transmitter power and the distance from the Base Station 133. Therefore, by scaling the transmitter power to correspond to the distance from the Base Station 133, the received signal magnitude can be maintained within a predetermined range of values to ensure accurate signal reception without interfering with other transmissions in the cell.

The voice communications between mobile subscriber station 101 and other subscriber stations, such as land line based subscriber station 109, is effected by routing the communications received from the mobile subscriber station 101 through the Telephone Switching Center 106 and trunks to the Public Switched Telephone Network (PSTN) 108 where the communications are routed to a Local Exchange Carrier 125 that serves land line based subscriber station 109. There are numerous Mobile Switching Centers 106 that are connected to the Public Switched Telephone Network (PSTN) 108 to thereby enable subscribers at both land line based subscriber stations and mobile subscriber stations to communicate between selected stations thereof. Data communications between mobile subscriber station 101 and other data communication systems, such as server 120, is effected by routing the data communications received from the mobile subscriber station 101 through IP network 107. This architecture represents the present architecture of the wireless and wire-line communication networks.

General Packet Radio Service

General Packet Radio Service (GPRS), as shown in FIG. 1A, is a packet network overlay that can be deployed to provide a 2.5G packet switched upgrade of the TDMA-based second generation (2G) circuit switched cellular communication networks: Global System for Mobile Communications (GSM), and the North American IS-136. The implementation of the Quality Packet Radio Service in the General Packet Radio Service packet network overlay on GSM cellular communication networks is described herein, in view of its present dominant position in serving over 70 percent of worldwide cellular subscribers. The extension of the General Packet Radio Service to the North American IS-136 cellular communication network is analogous to the implementation disclosed herein and the description of this implementation is omitted in the interest of brevity.

The General Packet Radio Service overlay over the circuit-switched GSM cellular communication network provides an independent IP-based packet-switched core network. The present evolution of General Packet Radio Service is designed primarily for providing best-effort packet services and permits IP-based applications such as Internet access in an efficient manner. However, a problem with the General Packet Radio Service packet-switched network overlay is that it is designed primarily for providing only best effort service to bursty data traffic in a spectrally efficient manner.

Multi-Protocol Label Switching

Multi-Protocol Label Switching (MPLS) is an IETF specification for attaching labels containing forwarding information to IP packets. Label switch/routers can “read” the labels a lot faster than they can look up destination information in routing tables. Multi-Protocol Label Switching has been described as bringing “ATM-like” traffic management features to switched connections, whether the protocol underlying those connections is asynchronous transfer mode (ATM), frame relay, or Internet Protocol (IP). Multi-Protocol Label Switched packets are encapsulated at ingress points with labels that are then used to forward packets along Label Switched Paths (LSP). Service providers can use bandwidth guaranteed Label Switched Paths as components of an IP Virtual Private Network (VPN) service, the bandwidth guarantee being used to satisfy customer service level agreements (SLA). The Label Switched Path is a virtual traffic trunk that carries flow aggregates generated by classifying the packets that arrive at the edge switch of a Multi-Protocol Label Switching network into “forwarding equivalence classes (FEC).

Network service providers have been leveraging connection-oriented data technologies—most notably, ATM and frame relay—to provide traffic engineering and class-of-service differentiation for some time. Multi-Protocol Label Switching promises to enable traffic engineering with IP technology—and produce some major gains in IP Quality of Service (QoS), when used in conjunction with such protocols as Differentiated Services (IETF method for specifying quality of service in IP networks) and Resource ReSerVation Protocol (RSVP) (a traffic engineering signaling protocol).

Universal Mobile Telecommunication Service Multi-Protocol Label Switching networks are presented here in two forms: as multi-service networks where a Multi-Protocol Label Switching core provides high speed cross connect for ATM, and as pure IP/Multi-Protocol Label Switching networks where IP router performs Label Edge Router (LER) functions with the core Label Switching Router (LSR). In these contexts the Dynamically Assignable Resource Class System enables 3GPP to allow “Resource Classes” to be allocated to a 3G Universal Mobile Telecommunication Service subscriber on a per session basis to enable Traffic Engineering, Virtual Private Networks, and transition to an all-IP Universal Mobile Telecommunication Service backbone. This Dynamically Assignable Resource Class System uses information in the RAB message [Traffic Class/Maximum Bit Rate/Guaranteed Bit Rate] to accomplish this. It does not require anything associated with IP QoS approaches to accomplish this. The resultant “Resource Class” will be used to enable Traffic Engineering, Virtual Private Networks, and transition to an all-IP Universal Mobile Telecommunication Service backbone. Thus, the Dynamically Assignable Resource Class System enables the provision of all the other traffic classes—Class 1 through Class 4 as specified by ETSI (European Telecommunications Standards Institute) UMTS (Universal Mobile Telephone System) Phase 2+ General Packet Radio Service recommendations—that will be supported by future 3G systems. These classes are:

| | |
|---|---|
| Conversational | Voice, video telephony (very low latency) |
| Streaming | Multimedia (preserve internal time relationship) |
| Interactive | Web browsing, games (preserve data integrity) |
| Background | E-mail (time insensitive, preserve data integrity) |

General Packet Radio Service Network Architecture

In order to understand the operation of the Dynamically Assignable Resource Class System, the underlying architecture of the General Packet Radio Service is described. The following description relates to the portion of the General Packet Radio Service that implements the access procedure implemented in the General Packet Radio Service medium.

The General Packet Radio Service network architecture, since it was originally designed to overlay GSM networks, is heavily based on GSM system concepts to achieve the maximum amount of interoperability and to require the least amount of additional infrastructure and modifications for implementing the overlay. The General Packet Radio Service enabled mobile subscriber stations (MS) communicate directly across the same GSM physical radio links with the GSM base station transceivers located in the cell sites. In the GSM Public Land Mobile Network (PLMN), Radio Network Controllers (RNC) control the radio links between the mobile subscriber station and the Base Station Transceiver, and a Base Station Transceiver and its associated BSC is called a Base Station Subsystem (BSS). The Radio Network Controllers are connected to the GSM Public Land Mobile Network backbone through mobile switching centers (MSC), which provide the switching, routing and transfer of intra-GSM Public Land Mobile Network voice, message and control signals. The gateway mobile switching center (GMSC) is the interface of the GSM Public Land Mobile Network to the public switched telephone network (PSTN). Communications between network elements in a GSM Public Land Mobile Network employ Signaling No. 7 (SSN7).

The General Packet Radio Service overlay adds two new network router elements: the Serving General Packet Radio Service Support Node (SGSN) and the Gateway General Packet Radio Service Support Node (GGSN). Hardware upgrades of the Base Station Subsystem are also required. A Channel Codec Unit (CCU) is incorporated into an existing Base Station Transceiver to enable General Packet Radio Service specific coding schemes. The Base Station Subsystems are connected to their serving GPRS Support Node. A Packet Control Unit Support Node (PCUSN) unit is added to each Base Station Subsystem to support the frame relay packet data interface between the Base Station Subsystem and the GPRS Support Node. The GPRS Support Nodes serve as the access routers to the General Packet Radio Service core network. The GGSN is the gateway router that interfaces the General Packet Radio Service core network to external IP or X.25/X.75 packet data networks (PDN). Circuit switched traffic destined to the PSTN continue to be routed from the Base Station Subsystem to the MSC and then through the GMSC on to the PSTN. On the other hand, packet switched traffic is independently routed from the Base Station Subsystem through its serving GPRS Support Node over the core General Packet Radio Service network to the GGSN, and on to Public Packet Data Networks.

General Packet Radio Service Protocol Architecture

Although it supports applications based on IP and X.25 (and potentially other packet data protocols), General Packet Radio Service specific protocols are employed within the General Packet Radio Service core network. FIG. 5 gives an illustration of the present version of the General Packet Radio Service protocol stack, the devices in which it is located and the interfaces between devices. In this structure, the following well-known elements are included:

| | |
|---|---|
| MS | Mobile Subscriber Station |
| BSS | Base Station Subsystem |
| SGSN | Serving General Packet Radio Service Support Node |
| GGSN | Gateway General Packet Radio Service Support Node |
| GTP | GPRS Tunnel Protocol |
| SNDCP | Sub-Network Dependent Convergence Protocol |
| BSSGP | Base Station GPRS Protocol |
| LLC | Logical Link Channel |
| RLC | Radio Link Control |
| MAC | Medium Access Channel |
| Gb | Interface between a SGSN and a Base Station Subsystem |
| Um | Interface between a mobile subscriber station and a GPRS |
| | fixed network part for providing packet network services |
| Gn | Interface between a SGSN and a GGSN |
| Gi | Interface between the GPRS network and other IP |
| | or X.25 networks |

The General Packet Radio Service Tunnel Protocol (GTP) is used to transfer packets between two General Packet Radio Service support nodes (e.g. SGSN, GGSN). The Tunnel Protocol encapsulates the IP or X.25 packet into a GTP Packet Data Unit (PDU). The GTP Packet Data Unit is routed over the IP-based General Packet Radio Service backbone network using either Transmission Control Protocol (TCP) for X.25-based applications or User Data Protocol (UDP) for IP-based applications. This process is called General Packet Radio Service tunneling. In transferring IP or X.25 packets between the mobile subscriber station and its serving GPRS Support Node, General Packet Radio Service uses a different set of network protocols, namely, the Sub-Network Dependent Convergence Protocol (Sub-Network Dependent Convergence Protocol) and the Logical Link Control (LLC) layers. The Sub-Network Dependent Convergence Protocol is used to map network protocol layer characteristics onto the specific characteristics of the underlying network. The Logical Link Control provides a secure logical pipe between the GPRS Support Node and each mobile subscriber station and performs such tasks as ciphering, flow control and error control. The Logical Link Control is used by the Sub-Network Dependent Convergence Protocol to transfer network layer Packet Data Units between the mobile subscriber station and it's serving GPRS Support Node. The Logical Link Control Packet Data Units are transferred over the radio link using the services provided by the Radio Link Control/Medium Access Control (RLC/MAC) protocol layer. The RLC/MAC protocol layer exists both within the mobile subscriber station and the Base Station Subsystem. The transfer of Logical Link Control Packet Data Units between multiple mobile subscriber stations and the core General Packet Radio Service network uses a shared radio medium. The Radio Link Control layer is responsible for:

1. Segmentation and re-assembly of Logical Link Control Packet Data Units.

2. Providing the option of including a link level automatic repeat request (ARQ) procedure for recovery of uncorrectable data block transmission errors.

The MAC layer operates between the mobile subscriber stations and the Base Station Subsystem and is responsible for:

1. Signaling procedures concerning radio medium access control

2. Performing contention resolution between access attempts, arbitration between multiple service requests from different mobile subscriber stations and medium allocations in response to service requests.

The RLC/MAC layer performance determines to a large extent the multiplexing efficiency and access delay of General Packet Radio Service applications over the radio interface.

Medium Access Procedures

General Packet Radio Service allows two types of access procedures for data transfer: one-phase or two-phase.

One-Phase Procedure

The mobile subscriber station sends a packet channel request over a Packet Random Access Channel. As discussed earlier, this random access burst occupies only 1 TDMA time slot. General Packet Radio Service uses a slotted ALOHA based random access procedure for contention resolution over the Packet Random Access Channel. The 8 or 11 bit information field encrypted in the 36 coded data bits in the random access burst carries only a limited amount of information, namely; the reason for the access: whether it is a one-phase or two-phase access or a page response; the mobile subscriber station class and radio priority; and the number of blocks to be transmitted (for page responses only). The identity of the mobile subscriber station or the connection and the amount of data to be transmitted (except for page responses) is not included in this channel request and is not known by the network at this time.

After receiving the packet channel request, the Base Station Subsystem replies with a packet uplink assignment message over the Packet Access Grant Channel paired with the Packet Random Access Channel that was used. This message contains the resource assignment for the mobile subscriber station including the carrier frequency, Temporary Flow Identifier, Uplink State Flag and other parameters so the mobile subscriber station can transmit over the assigned uplink Packet Data Traffic Channel. However, at this time the network is not aware of the mobile subscriber station identity and the service requested.

The Base Station Subsystem sends the Uplink State Flag over the downlink Packet Data Traffic Channel in the next logical frame paired to the assigned uplink Packet Data Traffic Channel.

The mobile subscriber station hears its Uplink State Flag and begins data transfer over the assigned uplink Packet Data Traffic Channel in the next logical frame. The Radio Link Control block transmitted includes an extended header with the type of service requested and the mobile identity via its Temporary Logical Link Identifier (TLLI).

When the network decodes the Temporary Logical Link Identifier successfully, it sends an acknowledgement to the mobile subscriber station in an uplink ACK/NAK message over the Packet Associated Control Channel. Contention resolution is completed on the network side; and after the mobile subscriber station successfully receives this acknowledgement, contention resolution is completed also on the mobile subscriber station side.

Data transfer from the mobile subscriber station to the Base Station Subsystem can continue with the mobile subscriber station listening to its Uplink State Flag to begin data transfer over the assigned Packet Data Traffic Channel.

Two-Phase Procedure

The mobile subscriber station sends a packet channel request in the same manner as in the one-phase procedure.

After receiving the packet channel request, the Base Station Subsystem replies with an uplink assignment message over the Packet Access Grant Channel. This assignment is a single block over an uplink Packet Associated Control Channel. This message contains the resource assignment for the mobile subscriber station including the carrier frequency, Temporary Flow Identifier, time slot and other parameters so the mobile subscriber station can transmit over the assigned Packet Associated Control Channel.

The mobile subscriber station sends a detailed packet resource request message over the assigned uplink Packet Associated Control Channel. This resource request includes the mobile Temporary Logical Link Identifier and the details of the service request.

In response to this request, the Base Station Subsystem then assigns the required resources to it using an uplink packet assignment message sent over the Packet Associated Control Channel. This message includes the carrier frequency, Temporary Flow Identifier and Uplink State Flag parameters so the mobile subscriber station can transmit over the assigned uplink Packet Data Traffic Channels.

The Base Station Subsystem sends the Uplink State Flag over the downlink Packet Data Traffic Channels in the next logical frame paired to the assigned uplink Packet Data Traffic Channels.

The mobile subscriber station hears its Uplink State Flag and begins data transfer over the assigned uplink Packet Data Traffic Channels in the next logical frame.

The choice of which of these two procedures to use is left to the General Packet Radio Service system operator. The essential difference is that in the one-phase procedure, the uplink data transfer begins concurrently with the service negotiation and mobile verification; whereas, in the two-phase procedure, the uplink data transfer only begins after the mobile verification and service negotiation is completed. Thus, the one-phase procedure can be somewhat faster than the two-phase procedure if the requested service negotiation is acceptable by the network and the mobile subscriber station application (a minimum of 3 to 4 logical frame times for the one-phase procedure compared with 4 to 5 logical frame times for the two-phase procedure in the absence of contention).

Dynamically Assignable Resource Class System

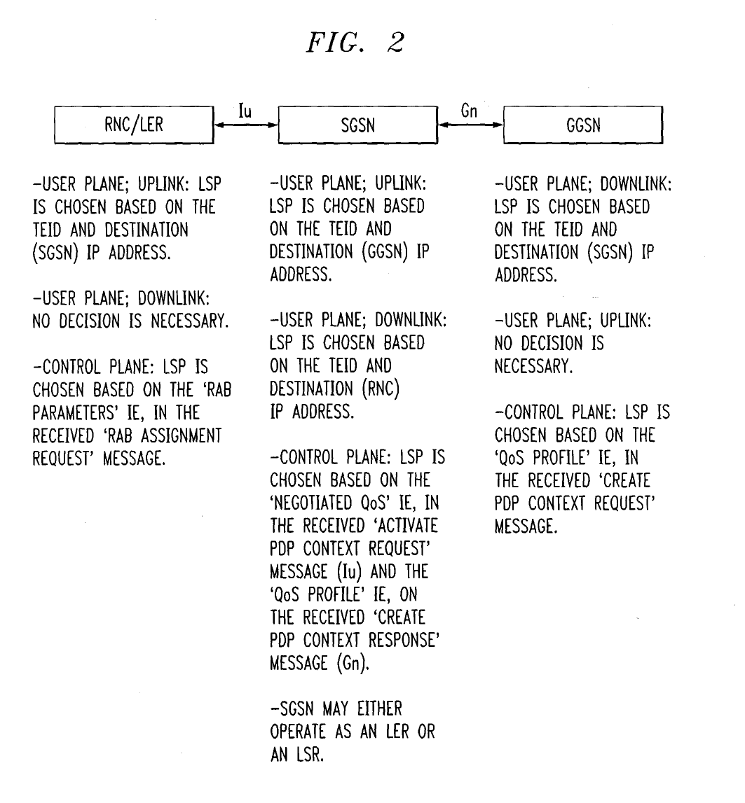

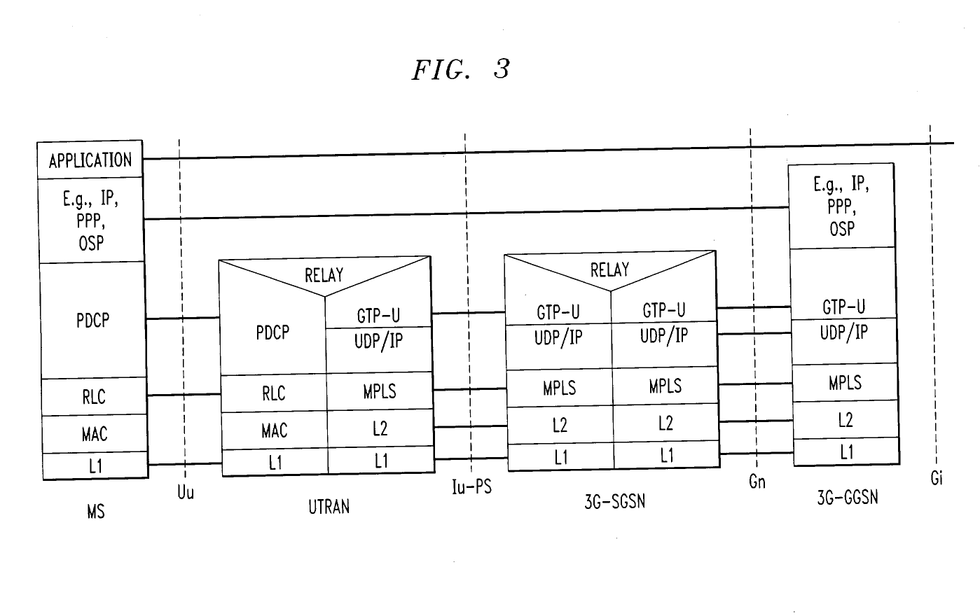

FIG. 2 illustrates the typical translation of a 3G-based Universal Mobile Telecommunication Service (UMTS) subscriber communications to a MPLS-based protocol; and FIG. 3 illustrates the User Plane—GTP-U/UDP/IP encapsulated in MPLS across lu-ps and Gn interfaces protocol stack for the present Dynamically Assignable Resource Class System.

The Universal Mobile Telecommunication Service Multi-Protocol Label Switched network can be implemented as either a TMX-880 based Multi-Protocol Label Switching Router (LSR) core network (manufactured by Lucent Technologies) which provides high speed cross connect function for Asynchronous Transfer Mode data communications, or alternatively as a pure IP/MPLS network where a Spring Tide edge router (manufactured by Lucent Technologies) performs Label Edge Router (LER) functions with the TMX-880 as the core Label Switching Router (LSR). The TMX-880 is a core switch manufactured by Lucent Technologies and is optimized to transport multi-service traffic over a single Multi-Protocol Label Switching backbone. This switch provides the capability to aggregate ATM traffic and transport this data over a high-speed Multi-Protocol Label Switching backbone. The SpringTide is an IP service switch router manufactured by Lucent Technologies and provides the capability to aggregate ATM traffic and edge routing. This router is typically installed between the core switch and the access apparatus. In both of these environments, the present dynamically assignable resource class system enables a 3GPP to allocate a resource class to a 3G UMTS subscriber on a per session basis. The Radio Access Bearer (RAB) message that provides Traffic Class/Maximum Bit Rate/Guaranteed Bit Rate QoS data is used to accomplish this. The resource class defined by this process is used to enable Traffic Engineering, Virtual Private Networks, and a transition to an all-IP UMTS backbone.

The Radio Base Station handles the radio transmission and reception to/from the handset over the radio interface (Uu). The Radio Base Station is controlled from the Radio Network Controller via the lub interface. The Radio Network Controller is the node that controls all Radio Access Network functions and connects the Radio Access Network to the core network via the lu interface. The Serving Radio Network Controller has overall control of the handset that is connected to the Radio Access Network. The Serving Radio Network Controller controls the connection on the lu interface for the handset and it terminates several protocols in the contact between the handset and the Radio Access Network. The Controlling Radio Network Controller has the overall control of a particular set of cells and their associated base stations. When a handset must use resources in a cell not controlled by its Serving Radio Network Controller, the Serving must ask the Controlling Radio Network Controller for the requested resources. The resource request is made via the lur interface which connects Radio Network Controllers with each other.

Within this framework, the Radio Access Bearer (RAB) is a channel that carries subscriber data between the handset and the core network. The characteristics of a Radio Access Bearer channel vary as a function of the type of service requested and the information to be transported. The Radio Access bearer channel includes an lu bearer channel between the Serving Radio Network Controller and the core network.

The process of establishing a communication connection with a selected class of service entails an originating Terminal Equipment initiating a communication connection and, on a user plane uplink basis, the Label Switching Router (LSR) is selected based on the Terminal Equipment Identifier (TEID) and the destination Serving General Packet Radio Service Support Node (SGSN) IP address. The user plane downlink is not selected at this juncture, but the control plane Label Switched Path (LSP) is selected based on the Radio Access Bearer parameters IE in the Radio Access Bearer assignment request message that is received from the Terminal Equipment.

Once these selections are effected, the Label Edge Router (LER) transmits the request to the destination Serving General Packet Radio Service Support Node (SGSN) where the SGSN on the user plane, uplink selects the destination Label Switched Path (LSP) based on the on the Terminal Equipment Identifier (TEID) and the destination Gateway General Packet Radio Service Support Node (GGSN) IP address. In the user plane downlink mode, the destination Serving General Packet Radio Service Support Node selects the destination Label Switched Path (LSP) based on the on the Terminal Equipment Identifier (TEID) and the destination Radio Network Controller IP address. The control plane is where the resource class assignment takes place with the destination Serving General Packet Radio Service Support Node selects the destination Label Switched Path (LSP) based on the Negotiated QoS IE in the received Activate PDP Context Request message lu received from the Label Edge Router (LER) and the QoS Profile IE on the received Create PDP Context Response message Gn received from the destination Label Edge Router (LER). In this environment, the Serving General Packet Radio Service Support Node (SGSN) can operate as either a Label Edge Router (LER) or a Label Switching Router (LSR).

At the destination Label Edge Router (LER) on a user plane downlink basis, the Label Switched Path (LSP) is selected based on the Terminal Equipment Identifier (TEID) and the destination Serving General Packet Radio Service Support Node (SGSN) IP address. The user plane uplink is not selected at this juncture, but the control plane Label Switched Path (LSP) is selected based on the QoS Profile IE on the received Create PDP Context Response message Gn received from the Serving General Packet Radio Service Support Node (SGSN).

Multi-Protocol Label Switching edge nodes are located at the Radio Network Controller (RNC) the Gateway General Packet Radio Service Support Node (GGSN) and the CN is the Multi-Protocol Label Switching Core and the Serving General Packet Radio Service Support Node (SGSN) may serve as a core LSR. In this arrangement, the lu interface as well as the Gn/Gi/Gp needs to be expanded to support Multi-Protocol Label Switching.

GTP-U Tunnels are used to carry encapsulated T-PDUs between a given pair of GTP-U Tunnel endpoints which are the Radio Network Controller (RNC) in the UTRAN and the Serving General Packet Radio Service Support Node (SGSN) for the interface lu-ps and the SGSN and General Packet Radio Service Support Node (GGSN) for interface Gn.

The Label Switched Paths (LSP) may be pre-established or established on demand, based on traffic requirements. When they are established on demand, the Label Switched Paths (LSP) can either be established per PDP context (or RAB) or, when there is not enough capacity on existing paths, more than one PDP context or RAB are carried on one Label Switched Path.

A mapping should be used between the Radio Access Bearer parameters IE in the Radio Access Bearer establishment request message and the parameters valid for a Label Switched Path (LSP). A suggested mapping is the following:

| Traffic Class | Mapping |
|---|---|
| RAB asymmetry indicator | Not mapped, but used to choose |
| from | a number of unidirectional LSPs |
| Maximum bit rate | PDR |
| Guaranteed bit rate | CDR |
| Maximum SDU size | Not mapped, but used to choose a |
| path | based on this value. |
| Traffic handling priority | Napped to new field |

Summary

The Dynamically Assignable Resource Class System enhances the existing slow access procedure implemented in the General Packet Radio Service medium to include fast in-session access capability. The Radio Access Bearer (RAB) message that provides Traffic Class/Maximum Bit Rate/Guaranteed Bit Rate QoS data is used to accomplish this. The resource class defined by this process is used to enable Traffic Engineering, Virtual Private Networks, and a transition to an all-IP UMTS backbone.

What is claimed:

1. A dynamically assignable class system for mapping subscriber communications to a General Packet Radio Service medium, comprising:
means, responsive to an originating Terminal Equipment initiating a communication connection, for designating, on a user plane uplink basis, the Label Switching Router (LSR) and the destination Serving General Packet Radio Service Support Node (SGSN) IP address; and
means for selecting a destination Label Switched Path (LSP) based on the Negotiated QoS received from the Label Edge Router (LER) and the QoS Profile IE received from the destination Label Edge Router (LER).

2. The dynamically assignable class system of claim 1 wherein said means for designating comprises:
means for selecting the Label Switching Router (LSR) based on the Terminal Equipment Identifier (TEID) and the destination Serving General Packet Radio Service Support Node (SGSN) IP address.

3. The dynamically assignable class system of claim 1 wherein said means for designating comprises:
means for selecting a destination Label Switched Path (LSP) based on the Negotiated QoS IE in the received Activate PDP Context Request message lu received from the Label Edge Router (LER) and the QoS Profile IE on the received Create PDP Context Response message Gn received from the destination Label Edge Router (LER).

4. The dynamically assignable class system of claim 3 wherein said means for designating further comprises:
means for selecting Label Switched Path (LSP) based on the Radio Access Bearer parameters IE in the Radio Access Bearer assignment request message that is received from the Terminal Equipment.

5. The dynamically assignable class system of claim 3 wherein said means for designating further comprises:
means for mapping between the IE parameter in the Radio Access Bearer establishment request message and the parameters valid for a Label Switched Path (LSP).

6. The dynamically assignable class system of claim 1 wherein said means for selecting comprises:
means for assigning a resource class in the control layer with the destination Serving General Packet Radio Service Support Node.

7. The dynamically assignable class system of claim 1 wherein said means for selecting comprises:
means for selecting a GTP-U Tunnel to carry encapsulated T-PDUs between a given pair of endpoints comprising a one of: the Radio Network Controller (RNC) in the UTRAN and the Serving General Packet Radio Service Support Node (SGSN) for a lu-ps interface; and the SGSN and General Packet Radio Service Support Node (GGSN) for a Gn interface.

8. A method for mapping subscriber communications to a General Packet Radio Service medium, comprising:
designating, in response to an originating Terminal Equipment initiating a communication connection, on a user plane uplink basis, the Label Switching Router (LSR) and the destination Serving General Packet Radio Service Support Node (SGSN) IP address; and
selecting a destination Label Switched Path (LSP) based on the Negotiated QoS received from the Label Edge Router (LER) and the QoS Profile IE received from the destination Label Edge Router (LER).

9. The method for mapping subscriber communications to a General Packet Radio Service medium of claim 8 wherein said step of designating comprises:
selecting the Label Switching Router (LSR) based on the Terminal Equipment Identifier (TEID) and the destination Serving General Packet Radio Service Support Node (SGSN) IP address.

10. The method for mapping subscriber communications to a General Packet Radio Service medium of claim 8 wherein said step of designating comprises:
selecting a destination Label Switched Path (LSP) based on the Negotiated QoS IE in the received Activate PDP Context Request message lu received from the Label Edge Router (LER) and the QoS Profile IE on the received Create PDP Context Response message Gn received from the destination Label Edge Router (LER).

11. The method for mapping subscriber communications to a General Packet Radio Service medium of claim 10 wherein said step of designating further comprises:
selecting Label Switched Path (LSP) based on the Radio Access Bearer parameters IE in the Radio Access Bearer assignment request message that is received from the Terminal Equipment.

12. The method for mapping subscriber communications to a General Packet Radio Service medium of claim 10 wherein said step of designating further comprises:
mapping between the IE parameter in the Radio Access Bearer establishment request message and the parameters valid for a Label Switched Path (LSP).

13. The method for mapping subscriber communications to a General Packet Radio Service medium of claim 8 wherein said step of selecting comprises:
assigning a resource class in the control layer with the destination Serving General Packet Radio Service Support Node.

14. The method for mapping subscriber communications to a General Packet Radio Service medium of claim 8 wherein said step of selecting comprises:
selecting a GTP-U Tunnel to carry encapsulated T-PDUs between a given pair of endpoints comprising a one of: the Radio Network Controller (RNC) in the UTRAN and the Serving General Packet Radio Service Support Node (SGSN) for a lu-ps interface; and the SGSN and General Packet Radio Service Support Node (GGSN) for a Gn interface.
